(19) United States
(12) Patent Application Publication
(10) Pub. No.: US 2008/0296078 A1
(43) Pub. Date: Dec. 4, 2008

(54) Torque transfer device with torque tube coupling mechanism

(75) Inventor: Russell T. Capito, Clarkston, MI (US)

Correspondence Address: HARNESS, DICKEY & PIERCE, P.L.C., P.O. BOX 828, BLOOMFIELD HILLS, MI, 48303, US

(73) Assignee: American Axle & Manufacturing, Inc.

(21) Appl. No.: 11/807,682

(22) Filed: May 30, 2007

(51) Int. Cl. F16H 37/06; G06F 17/00

(52) U.S. Cl. 180/247; 403/1; 701/69

(57) ABSTRACT

A power transmission device includes a rotatable input member, a rotatable output member and a friction clutch positioned within a housing. The friction clutch is operable to selectively transfer torque between the input member and the output member. A torque tube has a first end fixed to the friction clutch housing and a second end adapted to be fixed to an axle housing. The rotatable output member is supported to rotate within the torque tube and adapted to drivingly engage a rotatable member of an axle housing.

### BACKGROUND AND SUMMARY

The present disclosure relates generally to a power transmission device operable to selectively transfer torque between first and second sets of drivable wheels of a vehicle. More particularly, the present disclosure is directed to a power transmission device with a torque tube coupling mechanism.

Due to increased demand for four-wheel drive vehicles, power transmission systems are typically being incorporated into vehicle driveline applications for transferring drive torque to the wheels. Some vehicles include a power transmission device operably installed between the primary and secondary drivelines. Such power transmission devices are typically equipped with a torque transfer mechanism for selectively transferring drive torque from the primary driveline to the secondary driveline to establish a four-wheel drive mode of operation. At least one known torque transfer mechanism includes a dog-type lock-up clutch that may be selectively engaged for rigidly coupling the secondary driveline to the primary driveline when the vehicle is operated in four-wheel drive mode. Drive torque is delivered only to the primary driveline when the lock-up clutch is released and the vehicle operates in a two-wheel drive mode. This type of power transmission device may be directly mounted to the rear axle housing of the secondary driveline.

Another type of power transmission device, referred to as a transfer case, is operable for automatically directing drive torque to the secondary wheels without any input or action on the part of a vehicle operator. When traction is lost at the primary wheels, the four-wheel drive mode is entered. Some transfer cases are equipped with an electrically-controlled clutch actuator operable to regulate the amount of drive torque transferred to a secondary output shaft as a function of changes in vehicle operating characteristics such as vehicle speed, throttle position and steering angle. Typically, the transfer case includes a clutch positioned within a transfer case housing fixed to a vehicle transmission.

While many power transfer devices are currently used in four-wheel drive vehicles, a need exists to advance the technology. For example, the packaging requirements of the power transmission device may make such systems cost prohibitive in some four-wheel drive applications. In particular, vehicle manufacturers have an increased need for design flexibility with regard to the placement of the power transfer device relative to the vehicle fuel tank and a spare wheel and tire assembly.

A power transmission device includes a rotatable input member, a rotatable output member and a friction clutch positioned within a housing. The friction clutch is operable to selectively transfer torque between the input member and the output member. A torque tube has a first end fixed to the friction clutch housing and a second end adapted to be fixed to an axle housing. The rotatable output member is supported to rotate within the torque tube and adapted to drivingly engage a rotatable member of an axle housing.

Furthermore, a method of manufacturing a power transmission device is disclosed. The method includes defining a first tube set including a first torque tube having a first length and a first driveshaft having a first length. A second tube set is defined to include a second torque tube having a second length different from the first torque tube length and a second driveshaft having a second length different from the first driveshaft length. One of the first and second tube sets is selected. The torque tube from the selected tube set is fixed to a housing containing a friction clutch. The driveshaft from the selected tube set is drivingly connected to the friction clutch. The selected driveshaft is rotatably supported within the selected torque tube.

### DRAWINGS

The present disclosure will become more fully understood from the detailed description and the accompanying drawings, wherein:

FIG. 1 is a schematic of a four-wheel drive vehicle equipped with a power transmission device of the present disclosure;

FIG. 2 is a cross-sectional side view of the power transmission device of FIG. 1; and

FIG. 3 is a top view of the power transmission device of FIG. 1.

### DETAILED DESCRIPTION

The following description of the preferred embodiment(s) is merely exemplary in nature and is in no way intended to limit the disclosure, its application, or uses.

The present disclosure is directed to a power transmission device that may be adaptively controlled for modulating the torque transferred between a rotatable input member and a rotatable output member. The torque transfer mechanism may be useful within motor vehicle drivelines and easily positioned at a variety of axial positions spaced apart from a driving axle assembly. Accordingly, while the present disclosure is hereinafter described in association with a specific structural embodiment for use in a driveline application, it should be understood that the arrangement shown and described is merely intended to illustrate an exemplary use.

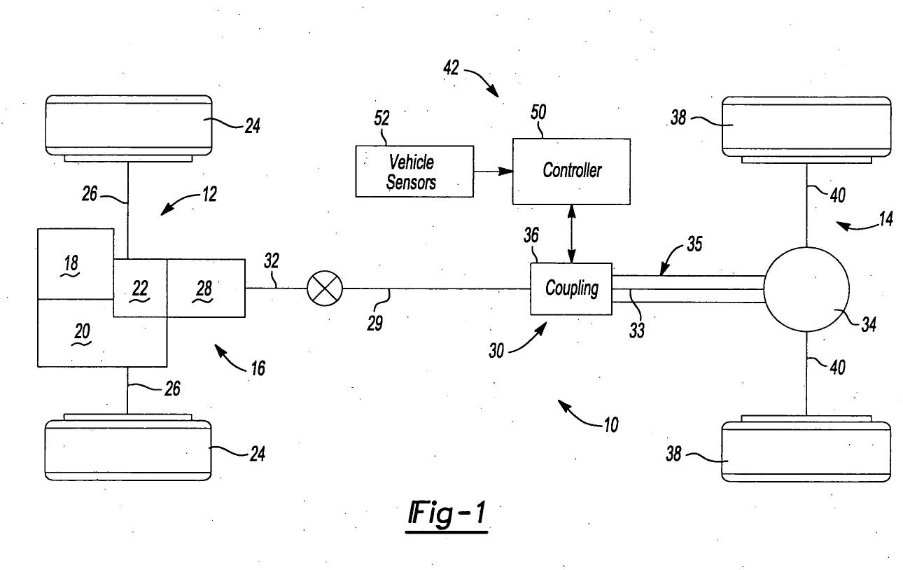

With reference to FIG. 1 of the drawings, a drive train 10 for a four-wheel vehicle is shown. Drive train 10 includes a first axle assembly 12, a second axle assembly 14 and a power transmission 16 for delivering drive torque to the axle assemblies. In the particular arrangement shown, first axle assembly 12 is the front driveline while second axle assembly 14 is the rear driveline. Power transmission 16 includes an engine 18 and a multi-speed transmission 20 having an integrated front differential unit 22 for driving front wheels 24 via axle shafts 26. A transfer unit 28 is also driven by transmission 20 for delivering torque to an input member 29 of a coupling 30 via a driveshaft 32. The input member 29 of the coupling 30 is coupled to driveshaft 32 while its output member 33 is coupled to a drive component of a rear differential 34. A torque tube assembly 35 rigidly interconnects a housing 36 of coupling 30 with an axle housing 37 of second axle assembly 14. Second axle assembly 14 also includes a pair of rear wheels 38 connected to rear differential 34 via rear axle shafts 40.

Drive train 10 is shown to include an electronically-controlled power transfer system 42 including coupling 30. Power transfer system 42 is operable to selectively provide drive torque in a two-wheel drive mode or a four-wheel drive mode. In the two-wheel drive mode, torque is not transferred via coupling 30. Accordingly, 100% of the drive torque delivered by transmission 20 is provided to front wheels 24. In the four-wheel drive mode, power is transferred through coupling 30 to supply torque to rear wheels 38. The power transfer system 42 further includes a controller 50 in communication with vehicle sensors 52 for detecting dynamic and operational characteristics of the motor vehicle. The controller 50 is operable to control actuation of coupling 30 in response to signals from vehicle sensors 52. The controller 50 may be programmed with a predetermined target torque split between the first and second sets of wheels. Alternatively, controller 50 may function to determine the desired torque to be transferred through coupling 30 via other methods. Regardless of the method used for determining the magnitude of torque to transfer, controller 50 operates coupling 30 to maintain the desired torque magnitude.

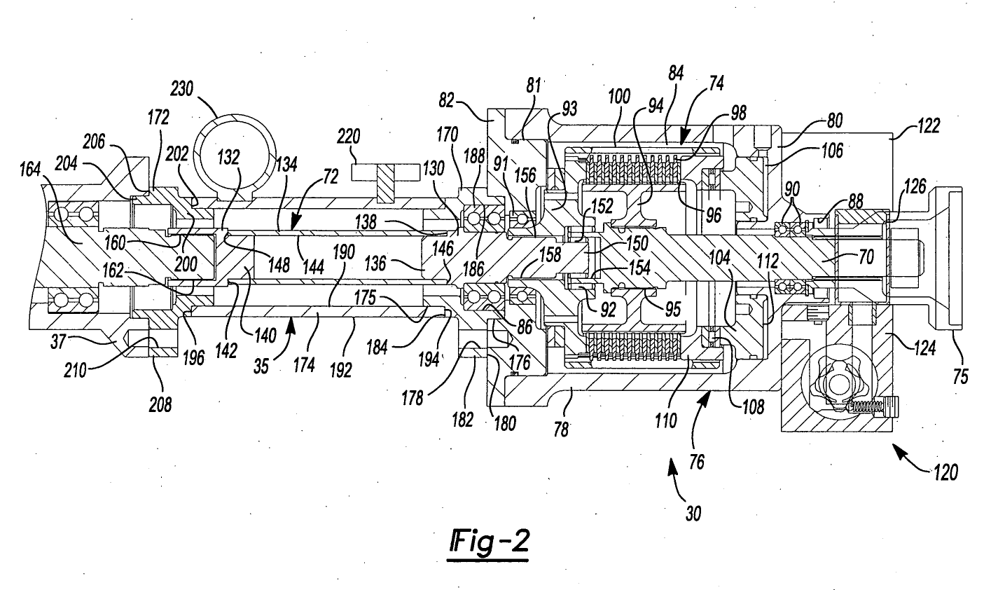

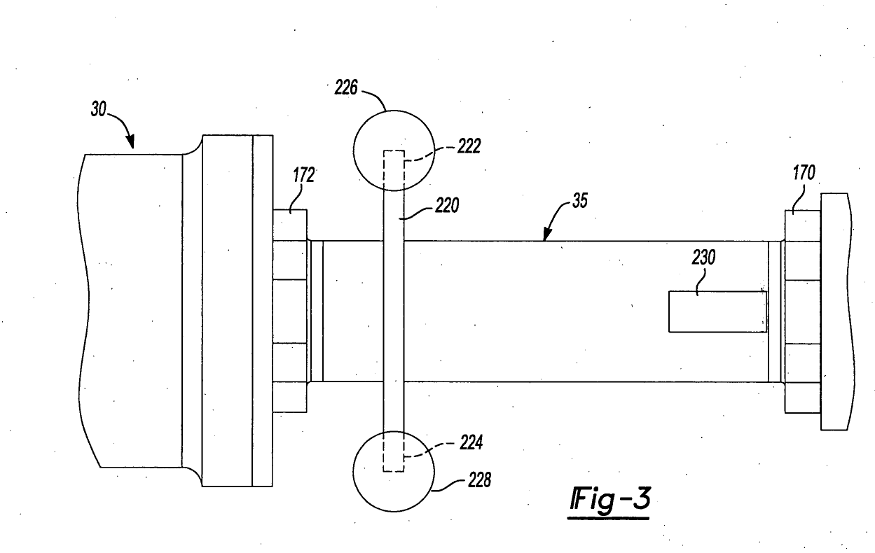

FIGS. 2-4 depict coupling 30 in greater detail. Coupling 30 includes an input shaft 70 selectively drivingly coupled to an output shaft or driveshaft 72 via a friction clutch 74. A drive flange 75 is mounted on one end of input shaft 70 to provide a mounting provision for a driveline component such as driveshaft 32.

Coupling 30 includes housing 36 having a substantially cup-shaped housing portion 76 with a substantially cylindrically-shaped side wall 78 and an end wall 80. Side wall 78 includes an internally threaded portion 81 near the open end of housing portion 76. An end cap 82 is threadably engaged with threaded portion 81 to complete housing 36 and define a cavity 84. End cap 82 includes an aperture 86 extending therethrough. End cap 82 may alternately be fastened to housing 76 by a number of bolts (not shown) extending through end cap 82 and threaded into housing 76.

A portion of output shaft 72 extends through aperture 86. Housing portion 76 includes an aperture 88 extending through end wall 80. A portion of input shaft 70 extends through aperture 88. Bearings 90 are positioned within aperture 88 to rotatably support input shaft 70. Bearings 91 and 92 rotatably support an output spindle 93. Input shaft 70 includes a splined portion 95 (FIG. 2) drivingly coupled to a hub 94. A set of inner friction plates 96 are drivingly coupled to hub 94 via a splined engagement. Inner friction plates 96 are interleaved with a plurality of outer friction plates 98. Outer friction plates 98 are in splined engagement with a drum 100. Drum 100 is drivingly coupled to output spindle 93. Output spindle 93 is coupled with output shaft 72 via another splined interface. In the embodiment depicted, friction clutch 74 is a wet clutch. Accordingly, clutch fluid is contained within cavity 84 in communication with friction plates 96 and 98.

A piston 104 is slidably positioned within a cavity 106 formed within housing portion 76. Piston 104 is axially moveable into engagement with a thrust bearing 108 and an apply plate 110. When pressurized fluid acts on a face 112 of piston 104, piston 104 translates and applies a force through thrust bearing 108 and apply plate 110 to the plurality of interleaved clutch plates 96 and 98. Torque is transferred between input shaft 70 and output shaft 72 via the components previously described when friction plates 96 and 98 are forced into contact with one another.

An actuator 120 is mounted to housing portion 76 to selectively supply pressurized fluid to cavity 106 and provide an apply force to friction clutch 74. Actuator 120 may include an electric motor 122, a pump 124, and a reservoir 126. Electric motor 122 includes an output shaft (not shown) drivingly engaged with pump 124 such that rotation of the output shaft of the electric motor causes fluid within reservoir 126 to be pressurized and enter cavity 106.

Output shaft 72 includes a first stub shaft 130, a second stub shaft 132 and a tube 134. First stub shaft 130 includes a reduced diameter portion 136 terminating at a shoulder 138. Second stub shaft 132 includes a reduced diameter portion 140 terminating at a shoulder 142. Tube 134 includes an inner surface 144 having a substantially circular shape in cross section. Inner surface 144 engages reduced diameter portions 136, 140 of first stub shaft 130 and second stub shaft 132, respectively. A first end face 146 of tube 134 engages shoulder 138 while a second end face 148 of tube 134 engages shoulder 142. Tube 134 may be fixed to first stub shaft 130 and second stub shaft 132 via welding or any other suitable method. First stub shaft 130 includes a pilot portion 150 at an opposite end from reduced diameter portion 136. A bearing 152 rotatably supports pilot portion 150 within a pocket 154 formed in input shaft 70. First stub shaft 130 also includes an externally splined portion 156 placed in driving engagement with an internal spline 158 formed on output spindle 93. Second stub shaft 132 includes an internally splined portion 160 in driving engagement with an external spline 162 formed on a pinion shaft 164 of rear differential 34.

Torque tube assembly 35 includes a first support 170, a second support 172 and an outer tube 174 positioned therebetween. First support 170 includes a reduced diameter first pilot 175 having a substantially cylindrical shape as well as a second pilot 176 also having a cylindrical shape. First pilot 175 terminates at a first pilot shoulder 178. Second pilot 176 extends from a mounting surface 180 of a radially outwardly extending flange 182. At least one aperture 184 extends through flange 182 and is in receipt of a fastener (not shown) fixing first support 170 to end cap 82. As previously discussed, end cap 82 forms a portion of housing 36. First support 170 includes a counterbore 186 in receipt of a bearing assembly 188 rotatably supporting first stub shaft 130.

Outer tube 174 is a substantially cylindrically shaped member having an inner surface 190, an outer surface 192, a first end face 194 and a second end face 196. First end face 194 engages first pilot shoulder 178 and a portion of inner surface 190 is supported on first pilot 175. Outer tube 174 may be fixed to first support 170 by any number of mechanisms including press fit, welding, riveting, adhesive bonding or the like.

Second support 172 includes a first pilot portion 200 terminating at a pilot shoulder 202. A second pilot portion 204 is formed at the opposite end of second support 172 from first pilot portion 200 and terminates at a mounting face 206 of a flange 208. An aperture 210 extends through flange 208 and is in receipt of a fastener (not shown) useful to fix flange 208 to axle housing 37 of second axle assembly 14. Outer tube 174 may be coupled to second support 172 in any of the ways previously described relating to connecting outer tube 174 to first support 170.

Once assembled, rear differential pinion shaft 164 and output shaft 72 extend through torque tube assembly 35. Output shaft 72 is rotatably supported and enclosed within outer tube 174. Because torque tube assembly 35 is constructed from a relatively inexpensive and easily manufactured outer tube 174 and output shaft 72 includes a similar easily manufactured and inexpensive tube 134, a spacing between coupling 30 and rear differential 34 may be varied to meet vehicle design parameters. It is contemplated that vehicle components including a spare tire, a spare tire well, a portion of a fuel tank or a variety of vehicle suspension components may be positioned between coupling 30 and second axle assembly 14.

To accomplish the goal of providing design flexibility for the axial position of coupling 30 relative to rear differential 34, a method of manufacturing a power transmission device includes defining a first tube set including a first torque tube having a first length and a first driveshaft having a first length where the length of the torque tube and the length of the driveshaft correspond to one another. Other tube sets may also be defined including a second tube set having a second torque tube with a second length different from the first torque tube length and a second driveshaft with a second length different from the first driveshaft length. Depending on the desired spacing between coupling 30 and second axle assembly 14, one of the first and second tube sets is selected. The torque tube from the selected tube set is fixed to housing 36 containing friction clutch 74. The driveshaft from the selected tube set is drivingly connected to friction clutch 74. The driveshaft or output shaft 72 is rotatably supported within the selected outer tube 174.

Depending on the length of torque tube assembly 35, external supporting elements may or may not be required. In the arrangement shown, a support bracket 220 is fixed to outer tube 174. Support bracket 220 extends transversely and terminates at a first end 222 and a second end 224. First end 222 is coupled to a vehicle frame or another vehicle suspension component (not shown) by a first support mount 226. Second end 224 is similarly coupled to a vehicle component (not shown) via a second support mount 228. First and second support mounts, 226, 228 may include various rate isolation bushings to tune the driveline and reduce noise, harshness and vibration.

A tube 230 longitudinally extends substantially parallel to outer tube 174 and is fixed thereto. Tube 230 may include a number of different plates, flanges or other attachment structures useful to couple outer tube 174 to the vehicle frame or a vehicle suspension component. In similar fashion to first and second support mounts 226, 228, tube 230 may be coupled to the vehicle using a rate isolation bushing to tune noise, harshness and vibration characteristics of the driveline. It should be appreciated that other support configurations not explicitly discussed may be employed with the torque tube assembly and coupling arrangement previously described without departing from the scope of the present disclosure.

Furthermore, the foregoing discussion discloses and describes merely exemplary embodiments of the present disclosure. One skilled in the art will readily recognize from such discussion, and from the accompanying drawings and claims, that various changes, modifications and variations may be made therein without department from the spirit and scope of the disclosure as defined in the following claims.

What is claimed is:

1. A power transmission device comprising:
a rotatable input member;
a rotatable output member;
a friction clutch positioned within a housing and being operable to selectively transfer torque between said input member and said output member; and
a torque tube having a first end fixed to said friction clutch housing and a second end adapted to be fixed to an axle housing, said rotatable output member being supported to rotate within said torque tube and adapted to drivingly engage a rotatable member within the axle housing.

2. The power transmission device of claim 1 wherein said torque tube includes a tube with a substantially cylindrical shape, a first support fixed to a first end of said tube and a second support fixed to a second end of said tube.

3. The power transmission device of claim 2 wherein said first support includes an aperture extending therethrough in receipt of said output member.

4. The power transmission device of claim 3 wherein said first support includes a pilot positioned within said tube.

5. The power transmission device of claim 4 wherein said first support includes a bore in receipt of a bearing rotatably supporting said output member.

6. The power transmission device of claim 2 wherein said second support includes a pilot positioned within said tube.

7. The power transmission device of claim 2 wherein said output member includes a drive tube, a first stub shaft fixed to a first end of said drive tube and a second stub shaft fixed to a second end of said drive tube.

8. The power transmission device of claim 7 wherein said first stub shaft is rotatably supported within said torque tube.

9. The power transmission device of claim 7 wherein a length of said tube and a length of said drive tube correspond to one another.

10. The power transmission device of claim 1 further including a transversely oriented support fixed to said tube and including ends adapted to be coupled to a vehicle structure.

11. The power transmission device of claim 10 further including a bracket fixed to said tube and spaced apart from said support, said bracket being adapted to be coupled to the vehicle structure.

12. The power transmission device of claim 1 further including an actuator operable to provide an actuating force to said friction clutch, said actuator including an electric motor coupled to a pump, said pump having an output in communication with a piston acting on said friction clutch.

13. The power transmission device of claim 12 further including a controller operable to determine a requested magnitude of torque and control said actuator to pressurize fluid within a closed cavity containing said piston acting on said friction clutch to generate said requested magnitude of torque, said controller being operable to vary the supply of electrical energy to said motor via pulse width modulation to vary the output of said pump and vary the output torque of said friction clutch.

14. A method of manufacturing a power transmission device, comprising:
defining a first tube set including a first torque tube having a first length and a first driveshaft having a first length;
defining a second tube set including a second torque tube having a second length different from said first torque tube length and a second driveshaft having a second length different from said first driveshaft length;
selecting one of said first and second tube sets;
fixing said torque tube from said selected tube set to a housing containing a friction clutch;
drivingly connecting said driveshaft from said selected tube set to said friction clutch; and
rotatably supporting said selected driveshaft within said selected torque tube.

15. The method of claim 14 further including fixing a first stub shaft to a first end of a hollow cylindrical member and fixing a second stub shaft to a second end of said hollow cylindrical member to form said selected driveshaft.

16. The method of claim 15 further including fixing a first support to a first end of a tube and fixing a second support to a second end of said tube to form said selected torque tube.

17. The method of claim 16 further including positioning a pilot of said first support within said tube.

18. The method of claim 17 further including fixing a transversely extending support to said selected torque tube.

19. The method of claim 14 further including fixing said selected torque tube to an axle housing.

20. The method of claim 19 further including drivingly coupling said selected driveshaft to a rotatable drive member within said axle housing.
